(19) United States
(12) Patent Application Publication
(10) Pub. No.: US 2022/0334326 A1
(43) Pub. Date: Oct. 20, 2022

(54) FIBER GRIPPING TOOL

(71) Applicant: COMMSCOPE TECHNOLOGIES LLC, Hickory, NC (US)

(72) Inventor: Lawrence Joseph SORENSON, Bloomington, MN (US)

(73) Assignee: COMMSCOPE TECHNOLOGIES LLC, Hickory, NC (US)

(21) Appl. No.: 17/639,252

(22) PCT Filed: Aug. 21, 2020
(86) PCT No.: PCT/US2020/047532

§ 371 Date: Feb. 28, 2022

Related U.S. Application Data
(60) Provisional application No. 62/894,352, filed on Aug. 30, 2019.

(51) Int. Cl. G02B 6/38; G02B 6/36

(52) U.S. Cl. CPC G02B 6/3898; G02B 6/3616

(57) ABSTRACT

A fiber gripping tool places optical fibers extending from optical connectors in an optical condition for cleaving. The fiber gripping tool can include a first gripper having a first clamping surface extending between a front edge and a rear edge, and a second gripper having a second clamping surface extending between a front edge and a rear edge, the second clamping surface facing the first clamping surface. In one aspect, when the first and second gripper are subjected to a closing force, the closing force causes the first and second clamping surfaces to be compressed against each other to grip an optical fiber and to be displaced in a fiber pulling direction towards the rear edges of the first and second clamping surfaces.

### CROSS-REFERENCE TO RELATED APPLICATION

This application is being filed on Aug. 21, 2020 as a PCT International Patent Application and claims the benefit of U.S. Patent Application Ser. No. 62/894,352, filed on Aug. 30, 2019, the disclosure of which is incorporated herein by reference in its entirety.

### BACKGROUND

As demand for telecommunications increases, fiber optic networks are being extended into more and more areas. As a result, there is a need for manufacturing efficiencies including for the fixtures and methods used in development of fiber optic devices, such as fiber optic connectors.

### SUMMARY

A fiber gripping tool is disclosed that secures and places tension on optical fibers extending from optical connectors. The fiber gripping tool can include a first gripper having a first clamping surface extending between a front edge and a rear edge, and a second gripper having a second clamping surface extending between a front edge and a rear edge, the second clamping surface facing the first clamping surface. In one aspect, when the first and second gripper are subjected to a closing force, the closing force causes the first and second clamping surfaces to be compressed against each other to grip an optical fiber and to be displaced in a fiber pulling direction towards the rear edges of the first and second clamping surfaces.

In some examples, the first clamping surface is defined by a first pad attached to the first gripper and wherein the second clamping surface is defined by a second pad attached to the second gripper.

In some examples, the first pad is received into a first recess of the first gripper and the second pad is received into a second recess of the second gripper.

In some examples, the first and second pads are formed from a polymeric material.

In some examples, the first and second grippers include a plurality of first and second grippers.

In some examples, the first and second grippers include twelve first grippers and twelve second grippers.

In some examples, the first and second grippers are respectively attached to a first block and a second block movable relative to the first block.

In some examples, the first and second grippers are respectively integrally formed with the first and second blocks.

In some examples, the first gripper includes a first flexible stand-off member and the second gripper includes a second flexible stand-off member, wherein the closing force causes the first and second flexible stand-off members to deflect such that the first and second clamping surfaces are displaced towards their rear edges.

In some examples, the first flexible stand-off member includes a pair of flexible stand-off members and the second flexible stand-off member includes a pair of flexible stand-off members.

In some examples, the first and second stand-off members are oriented at an oblique angle with respect to the first and second clamping surfaces.

In some examples, the tool further includes a cleave guide for guiding a cleaving tool.

In some examples, the cleave guide is at least one of a vertical wall and a horizontal wall.

In one example, a fiber gripping tool includes a first gripper defining a first end portion and a first stand-off member extending at an oblique angle from the first end portion, the first end portion defining a first clamping surface and a second gripper defining a second end portion and a second stand-off member extending at an oblique angle from the second end portion, the second end portion defining a second clamping surface. In one aspect, when the first and second gripper are subjected to a closing force, the closing force causes the first and second clamping surfaces to be compressed against each other to grip an optical fiber and causes the first and second stand-off members to deflect, thereby displacing the first and second clamping surfaces in a first direction parallel to the first and second clamping surfaces.

In some examples, the first clamping surface is defined by a first pad attached to the first gripper and wherein the second clamping surface is defined by a second pad attached to the second gripper.

In some examples, the first pad is received into a first recess of the first gripper and the second pad is received into a second recess of the second gripper.

In some examples, the first and second pads are formed from a polymeric material.

In some examples, the first and second grippers include a plurality of first and second grippers.

In some examples, the first and second grippers include twelve first grippers and twelve second grippers.

In some examples, the first and second grippers are respectively attached to a first block and a second block movable relative to the first block.

In some examples, the first and second grippers are respectively integrally formed with the first and second blocks.

In one example, a method for gripping and cleaving an optical fiber extending from an optical connector can include the steps of supporting an end of the optical connector with a fiber gripping tool, placing the optical fiber extending from the optical connector between a pair of fiber grippers, generating a closing force to cause the pair of fiber grippers to clamp the optical fiber and to pull the optical fiber in a direction away from the optical connector, and cleaving the optical fiber with a cleaving tool proximate the optical connector.

In some examples, the step of generating a closing force includes operating a lever of the fiber gripping tool into a clamped position.

In some examples, the closing force causes the fiber grippers to simultaneously clamp and pull the optical fiber.

In some examples, the closing force causes flexible stand-off members of the fiber grippers to deflect.

In some examples, the supporting, placing, and generating a closing force steps include supporting a plurality of optical connectors, placing a plurality of optical fibers between one or more pairs of fiber grippers, and generating a closing force on the plurality of optical fibers to cause the one or more pairs of fiber grippers to clamp each of the plurality of optical fibers and to pull each of the plurality of optical fibers in a direction away from the optical connectors.

A variety of additional inventive aspects will be set forth in the description that follows. The inventive aspects can relate to individual features and combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

Non-limiting and non-exhaustive embodiments are described with reference to the following figures, which are not necessarily drawn to scale, wherein like reference numerals refer to like parts throughout the various views unless otherwise specified.

FIG. 1 is a front perspective view of a fiber gripping tool having features in accordance with the present disclosure.

FIG. 2 is a rear perspective view of the fiber gripping tool shown in FIG. 1.

FIG. 3 is a side view of the fiber gripping tool shown in FIG. 1.

FIG. 4 is a rear end view of the fiber gripping tool shown in FIG. 1.

FIG. 5 is a front end view of the fiber gripping tool shown in FIG. 1.

FIG. 6 is a top view of the fiber gripping tool shown in FIG. 1.

FIG. 7 is a bottom view of the fiber gripping tool shown in FIG. 1.

FIG. 8 is an exploded view of the fiber gripping tool shown in FIG. 1.

FIG. 9 is a front perspective view of a support beam of the fiber gripping tool shown in FIG. 1.

FIG. 10 is a rear perspective view of the support beam shown in FIG. 9.

FIG. 11 is a front view of the support beam shown in FIG. 9.

FIG. 12 is a rear view of the support beam shown in FIG. 9.

FIG. 13 is a top view of the support beam shown in FIG. 9.

FIG. 14 is a side view of the support beam shown in FIG. 9.

FIG. 15 is a perspective view of a bottom clamp block of the fiber gripping tool shown in FIG. 1.

FIG. 16 is a side view of the bottom clamp block shown in FIG. 15.

FIG. 17 is a top view of the bottom clamp block shown in FIG. 15.

FIG. 18 is a bottom view of the bottom clamp block shown in FIG. 15.

FIG. 19 is a perspective view of a top clamp block of the fiber gripping tool shown in FIG. 1.

FIG. 20 is a side view of the top clamp block shown in FIG. 19.

FIG. 21 is a top view of the top clamp block shown in FIG. 19.

FIG. 22 is a bottom view of the top clamp block shown in FIG. 19.

FIG. 23 is a perspective view of the fiber gripping tool shown in FIG. 1 receiving a plurality of optical connectors supported by a fiber carrier.

FIG. 24 is a side view of the fiber gripping tool, the fiber carrier, and the plurality of optical connectors shown in FIG. 23.

FIG. 25 is an enlarged side view of the fiber gripping tool, the fiber carrier, and the plurality of optical connectors shown in FIG. 24.

FIG. 26 is a partial perspective view of the fiber gripping tool, the fiber carrier, and the plurality of optical connectors shown in FIG. 23.

FIG. 27 is a partial perspective cross-sectional view of the fiber gripping tool, the fiber carrier, and the plurality of optical connectors shown in FIG. 26.

FIG. 28 is a cross-sectional side view of the fiber gripping tool, the fiber carrier, and the plurality of optical connectors shown in FIG. 26.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

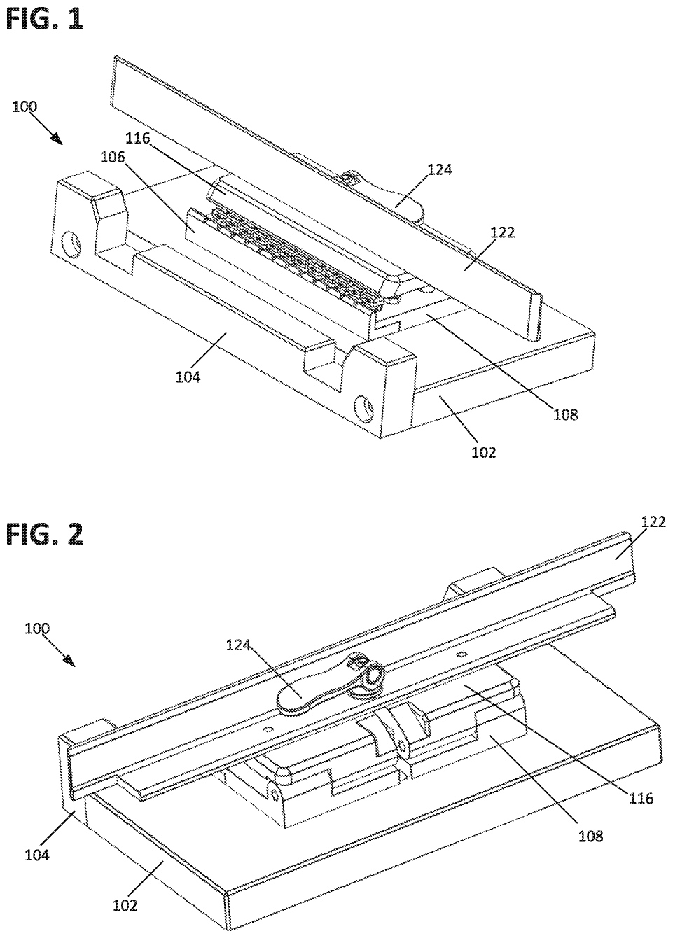

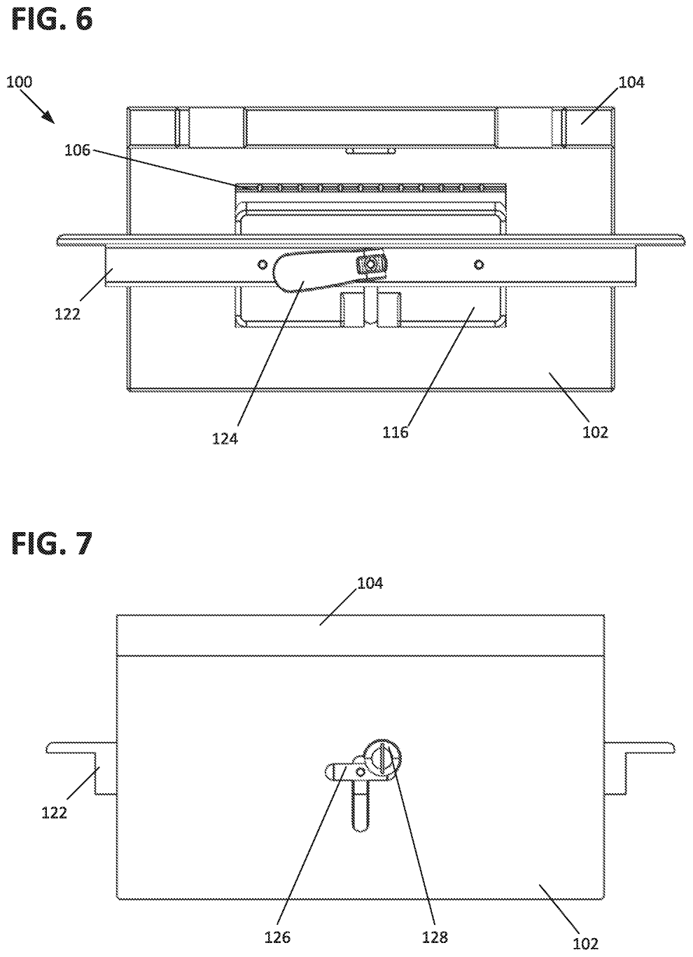

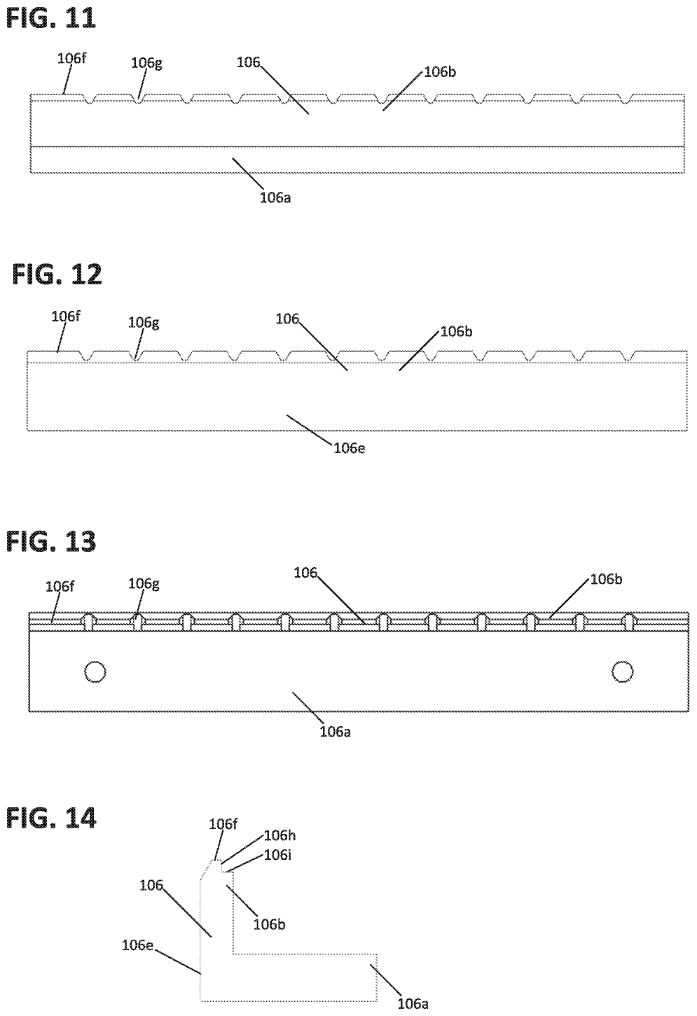

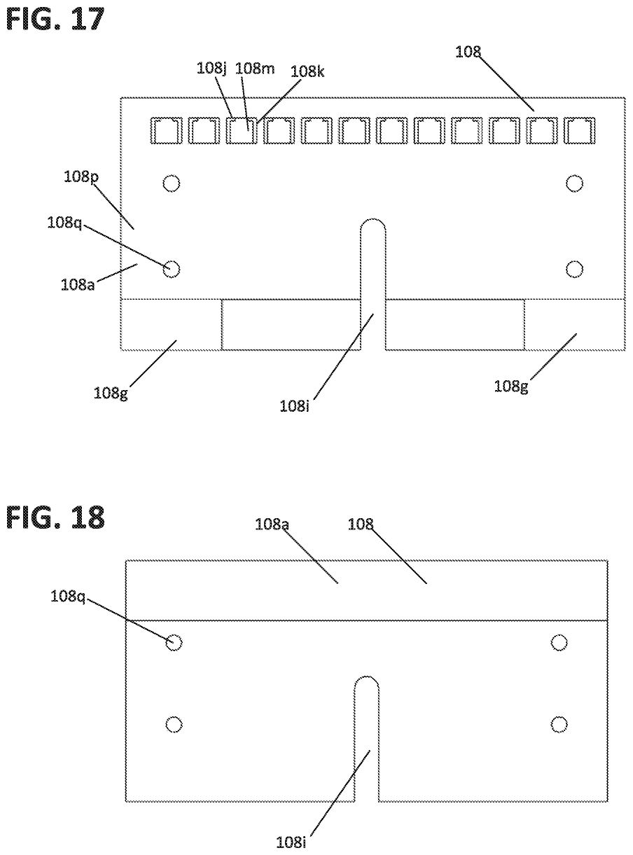

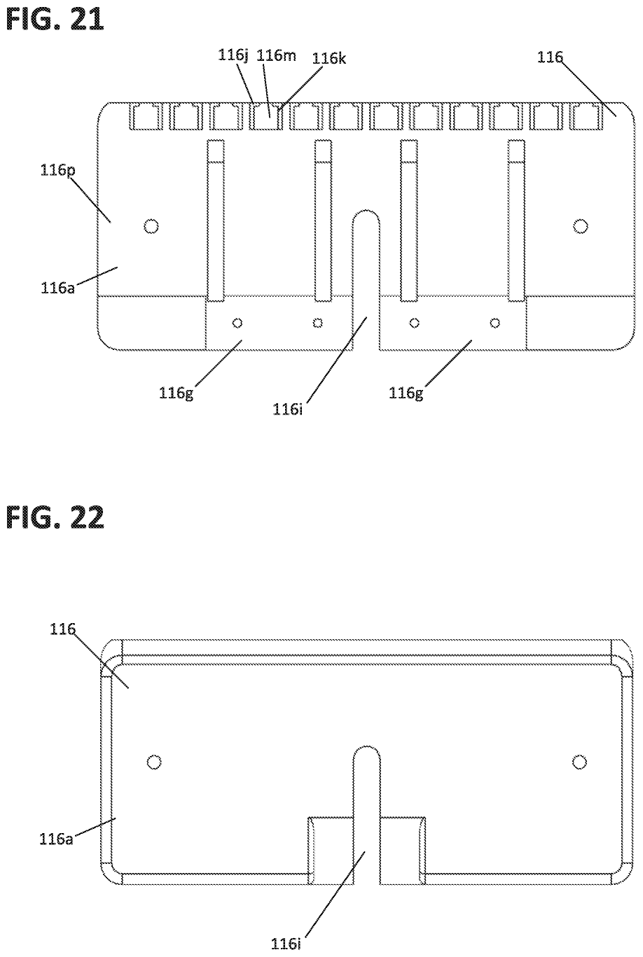

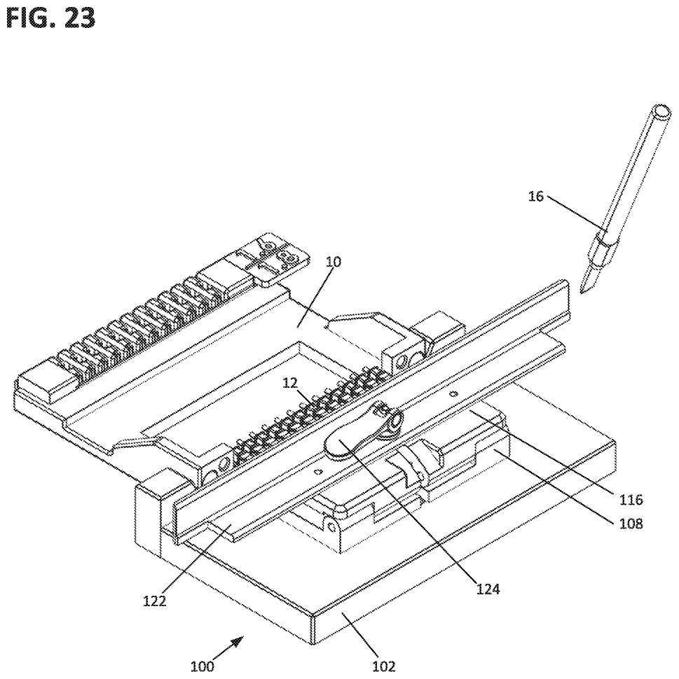

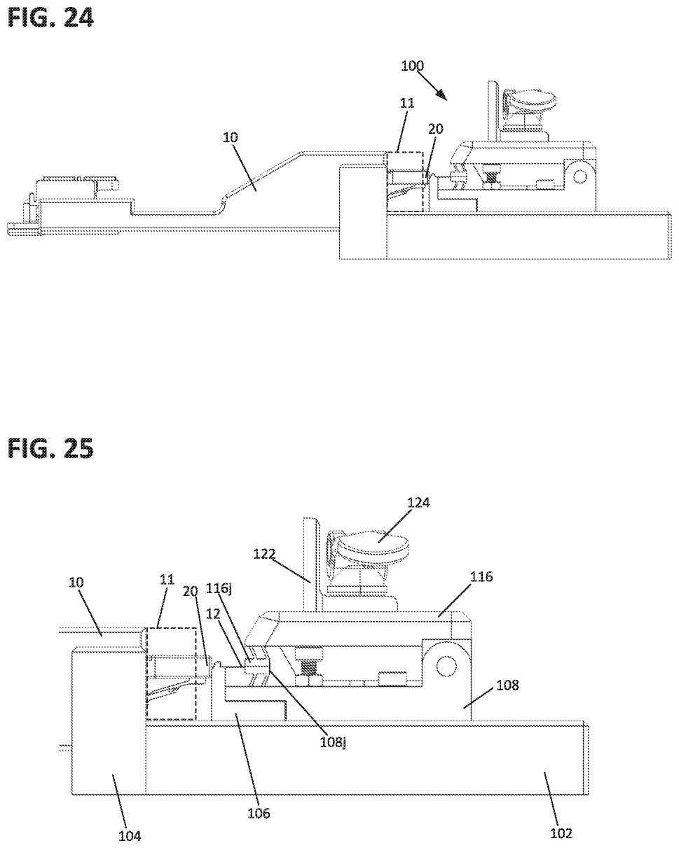

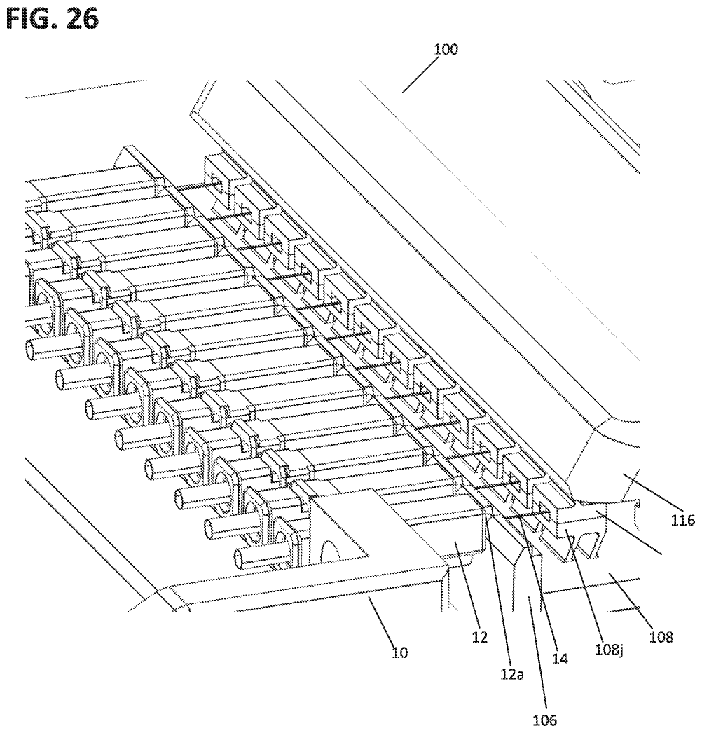

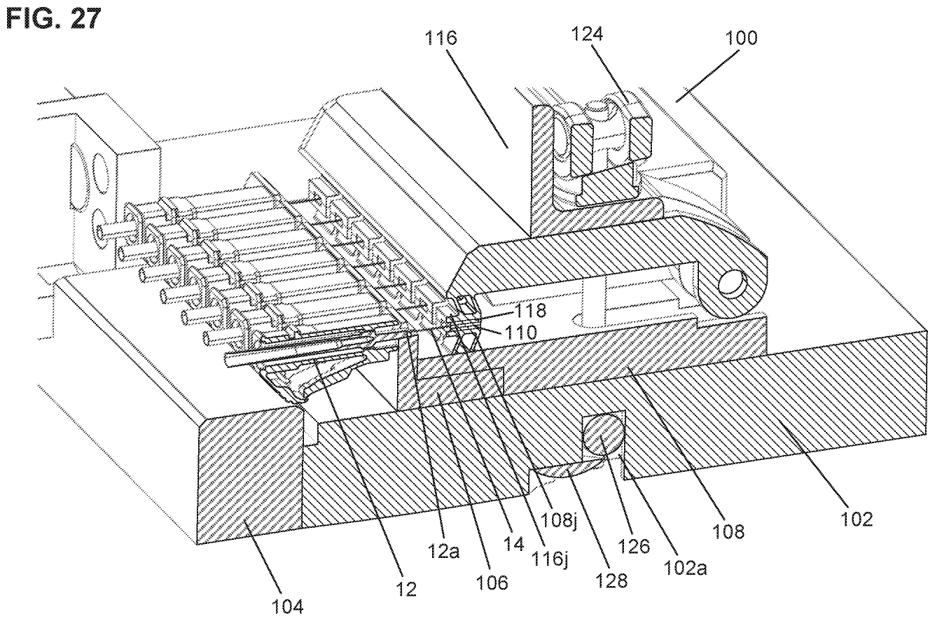

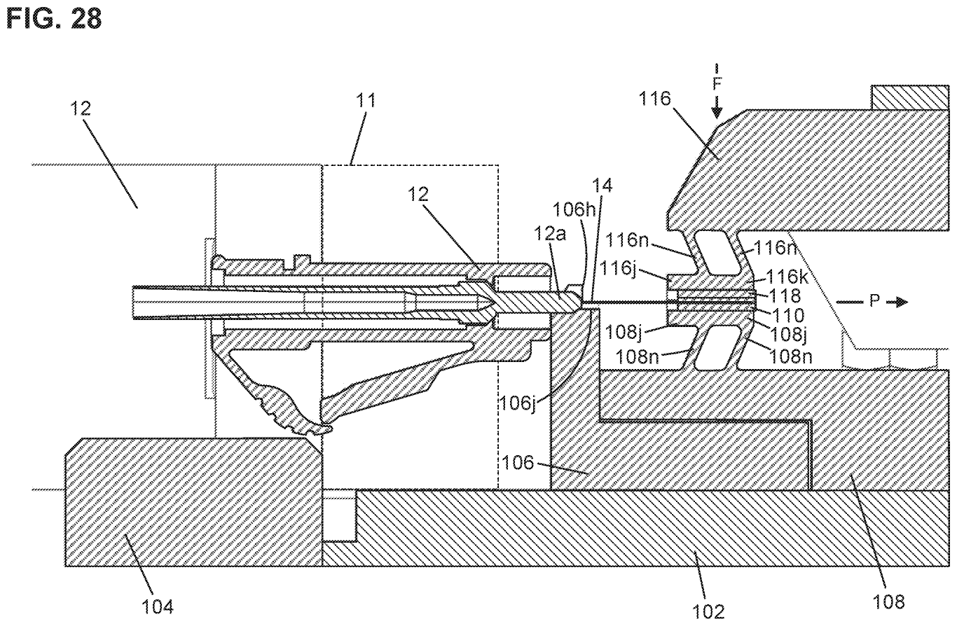

With reference to FIGS. 1 to 22, a fiber gripping tool 100 and components thereof are illustrated. FIGS. 23 to 28 additionally show a fiber carrier 10 and an attached connector carrier 11, shown at FIGS. 24, 25, and 28, mounted to the fiber gripping tool 100. For the purpose of clarity, the connector carrier 11 is shown only schematically such that other features can be more easily viewed. The fiber carrier 10 and connector carrier 11 are respectively configured to support fiber optic cables (not shown) and fiber optic connectors 12, wherein the fiber optic cables extend from the fiber optic connectors 12 in one direction and the associated optical fiber 14 extend in the opposite direction through the connectors 12. In one aspect, the fiber carrier 10 and/or connector carrier 11 is mounted to the fiber gripping tool 100 such that ferrules 12a of each of the fiber optic connectors 12 is supported by the fiber gripping tool 100. Once the fiber carrier is mounted to the fiber gripping tool 100, the optical fibers 14 are clamped and placed under tension by the fiber gripping tool 100 so that the optical fibers 14 can be cleaved on the fiber gripping tool 100 with a cleaving tool 16. One example of a suitable fiber carrier 10 and connector carrier 11 is shown and described in U.S. Provisional Patent Application Ser. Nos. 62/894,328 and 63/036,313, commonly owned and entitled FIBER CARRIER, the entirety of which is incorporated herein by reference. A suitable connector carrier 11 is also shown and described in U.S. Provisional Patent Application Ser. No. 62/826,546, filed on Mar. 29, 2019 and entitled FIBER OPTIC CONNECTOR FABRICATION CARRIER, the entirety of which is incorporated herein by reference.

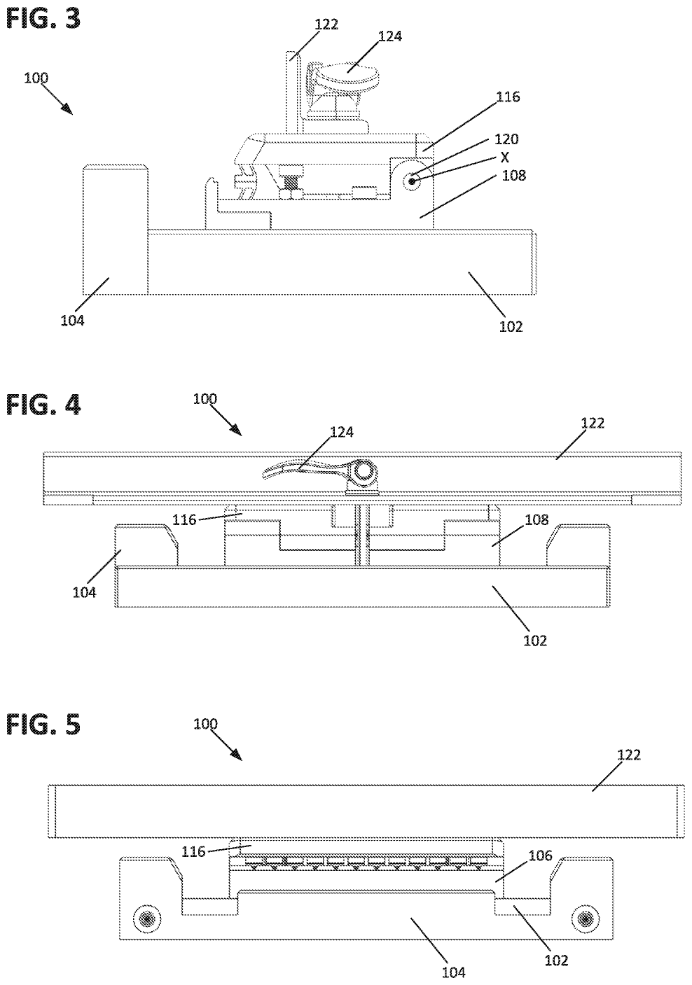

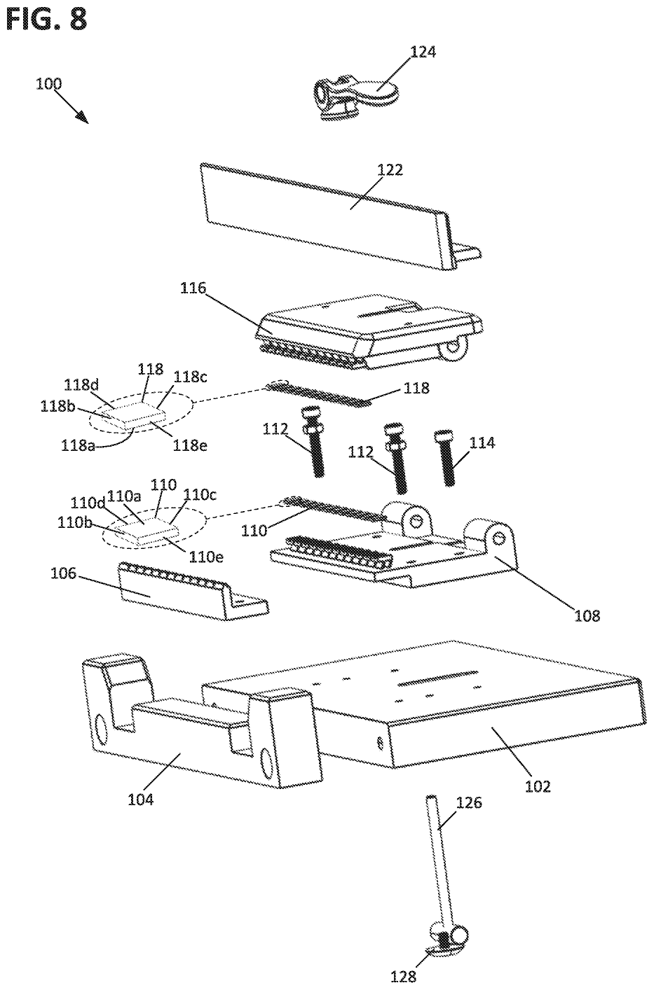

In the example shown, and as most easily viewed at FIG. 8, the fiber gripping tool 100 can include a number of components. For example, the fiber gripping tool can include a base 102 to which the other components of the fiber gripping tool 100 are operably mounted. In one aspect, a fixture 104 is mounted to a front end of the base 102 that operates to secure the fiber carrier 10 to the fiber gripping tool 100. A support plate 106 is also shown as being provided and mounted to the base 102. The support plate 106 operates to provide a support surface for the fiber optic connectors 12 such that ferrules 12a of the fiber optic connectors 12 are supported and such that the connectors 12 are blocked from being pulled in the pulling direction D1 when the fiber gripping tool 100 is gripping and pulling the optical fibers 14 associated with the connectors 12. Also mounted to the base 102, and in overlapping fashion with the support plate 106, is a bottom clamp part 108. The bottom clamp part 108 and the support plate are bolded to the base 102 via fasteners 112, 114. Rotatably coupled to the bottom clamp part 108 is an upper clamp part 116, which is connected via a pin 120 which enables the top clamp part 116 to rotate with respect to the bottom clamp part 108 about a pivot axis X defined by the pin 120. The pin 120, not illustrated at FIG. 8, is shown in an installed position at FIG. 3.

Pads 110, 118 are respectively provided on the bottom and top clamp parts 108, 116 such that the optical fibers 14 can be more effectively gripped between clamping surfaces 110a, 118a of the pads 110, 118 during the clamping operation. The pads 110, 118 can be formed from a polymeric material, such as a plastic-type material or a rubber-type material such that the pads 110, 118 are flexible and resilient. In one aspect, the clamping surfaces 110a, 118a of the pads 110, 118 extend between front edges 110b, 118b, rear edges 110c, 118c, and side edges 110d, 110e, 118d, 118e.

The fiber gripping tool 100 is also shown as being provided with a press bar 122 located above and in contact with the top clamp part 116. The press bar 122 provides a surface against which a clamping assembly can operate. The clamping assembly can include a cam lever 124 operably connected to a post 126, which is secured within a recess 102a in the base 102. When the cam lever 124 is operated into a locked position, the post 126 is placed in tension, which results in a closing force F being generated to cause the top and bottom clamp parts 108, 116 to be compressed against each other such that the pads 110, 118 grip the optical fibers extending therebetween. A keeper 128 can also be provided at the bottom side of the base 102 to maintain the t-shaped portion of the post 126 within the recess 102a of the base 102.

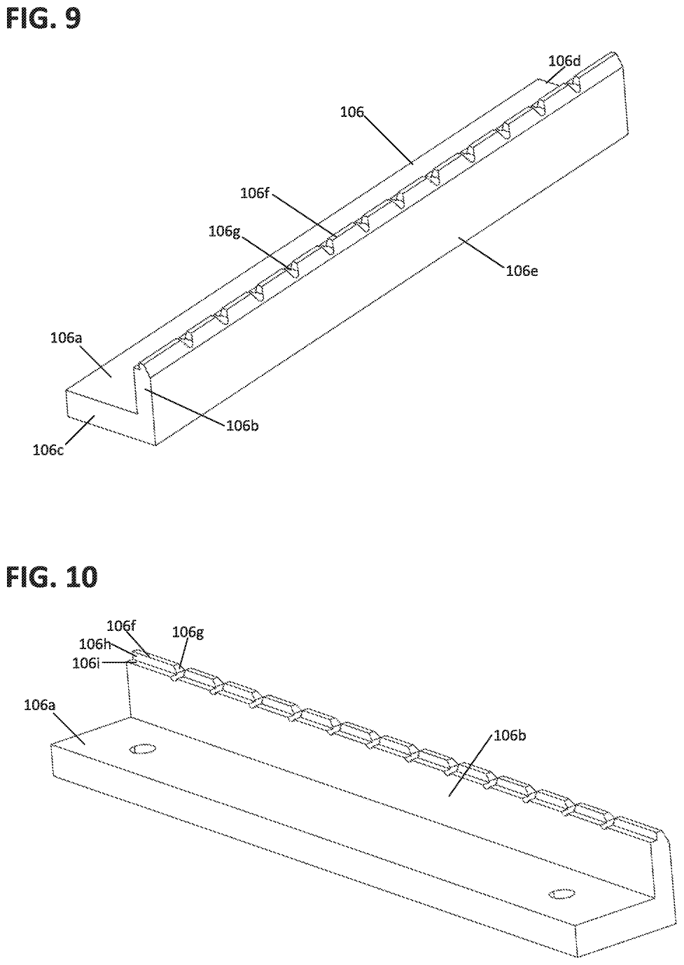

With reference to FIGS. 9-14, the support bar 106 is shown in further detail. As shown, the support bar 106 is a unitarily formed L-shaped body with a first portion 106a and a second portion 106b extending between a first end 106c and a second end 106d. In the orientation shown, the first portion 106a is horizontal and resides beneath the bottom clamp part 108, and the second portion 106b is vertical and extends in front of the bottom clamp part 108. The second portion 106b defines a front face 106e which functions as a stop against the connectors 12 such that the connectors 12 are prevented from moving toward the bottom and top clamp parts 108, 116. The top edge 106f of the second portion 106b includes a plurality of channels or recesses 106f configured to receive and support a ferrule 12a of the connector 12. The second portion 106b is also provided with a rear face 106h and a ledge or shelf 106i extending from the rear face 106h proximate the top edge 106f. In the configuration shown, the ferrules 12a do not extend past the first rear face 106h of the second portion 106b leaving the optical fiber 14 exposed at the location of the rear face 106h and the ledge or shelf 106i. When using a manual cleaving tool 200, the rear face 106h and/or the ledge or shelf 106i act as a guide when cleaving the optical fibers 14. Accordingly, this feature can be characterized as a cleaving guide being provided on the support bar.

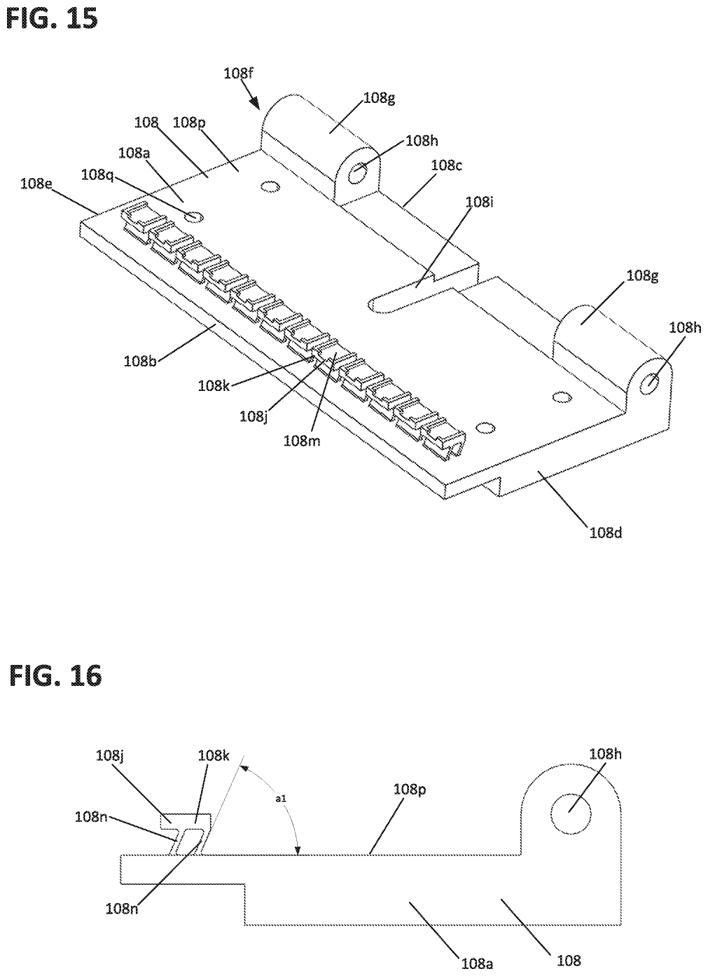

With reference to FIGS. 15 to 18, the bottom clamp block 108 is shown in further detail. As shown, the bottom clamp block 108 includes a main body 108a extending between a front edge 108b, a rear edge 108c, and side edges 108d, 108e. In one aspect, the main body 108a defines a hinge portion 108f with a pair of extensions 108g defining apertures 108h for receiving the pin 120 such that the top clamp block 116 can be rotatably connected to the bottom clamp block 108. The main body 108a also defines a slot 108i through which the post 126 can extend. The main body 108a further includes a plurality of apertures 108q for receiving the fasteners 112, 114 such that the bottom clamp block 108 can be secured to the base 102.

In one aspect, the bottom clamp block 108 includes a plurality of fiber grippers 108j. As shown, each fiber gripper 108j has an end portion 108k defining a recess 108m for receiving one of the pads 110. The recess 108m and pads 110 are dimensioned such that the pads 110 fit within an inner perimeter defined by the recesses 108m and such that the top surface 110a of the pads 110 extends beyond the end portion 108k. This configuration allows for the top surface 110a of the pads 110 to define a resilient fiber clamping surface 110a associated with each of the fiber grippers 108j. In one aspect, the end portions 108k are supported by a pair of deflectable stand-off members 108n which connect the main body 108a to the end portions 108k. In the example shown, the end portions 108k and the stand-off members 108n are integrally formed into the main body 108a, however, these features of the fiber grippers 108j could be separately formed and later connected to the bottom clamp block 108. In the example shown, the stand-off members 108n extend at a non-orthogonal, oblique angle a1 to a top surface 108p of the bottom clamp block main body 108a. Accordingly, the stand-off members 108n are oriented at a non-orthogonal, oblique angle to the fiber clamping surface 110a defined by the pad 110 received by the fiber grippers 108j. As most easily seen at FIG. 16, the angle a1 is between about 45 degrees and about 75 degrees, and is preferably about 66 degrees.

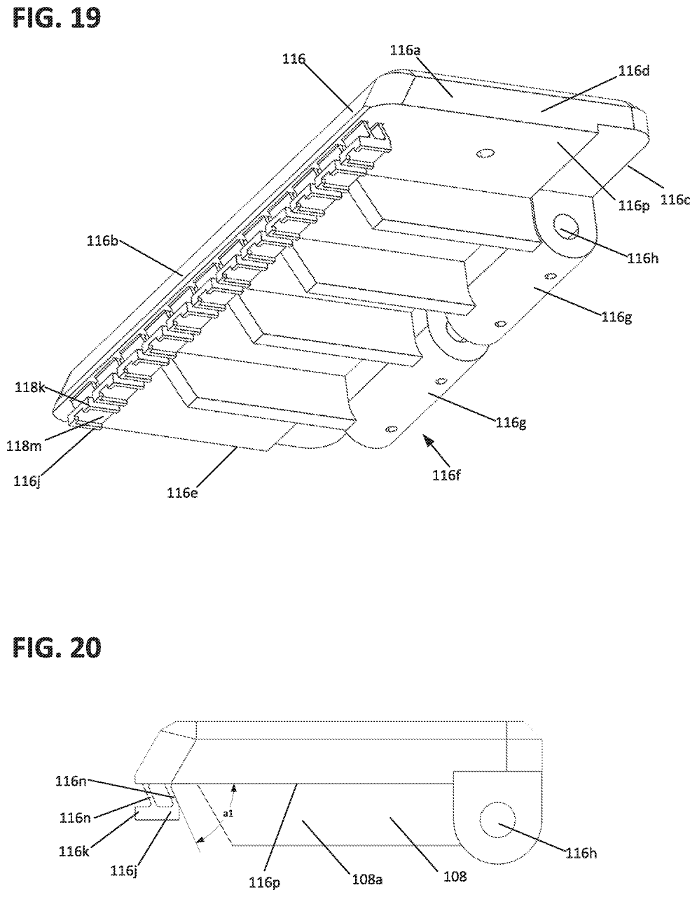

With reference to FIGS. 19 to 22, the top clamp block 116 is shown in further detail. As shown, the top clamp block 116 includes a main body 116a extending between a front edge 116b, a rear edge 116c, and side edges 116d, 116e. In one aspect, the main body 116a defines a hinge portion 116f with a pair of extensions 116g defining apertures 116h for receiving the pin 120 such that the top clamp block 116 can be rotatably connected to the bottom clamp block 108. The main body 116a also defines a slot 116i through which the post 126 can extend.

In one aspect, the top clamp block 116 includes a plurality of fiber grippers 116j. As shown, each fiber gripper 116j has an end portion 116k defining a recess 116m for receiving one of the pads 118. The recess 116m and pads 118 are dimensioned such that the pads 118 fit within an inner perimeter defined by the recesses 116m and such that the top surface 118a of the pads 118 extends beyond the end portion 116k. This configuration allows for the top surface 118a of the pads 118 to define a resilient fiber clamping surface 118a associated with each of the fiber grippers 116j. In one aspect, the end portions 116k are supported by a pair of deflectable stand-off members 116n which connect the main body 116a to the end portions 116k. In the example shown, the end portions 116k and the stand-off members 116n are integrally formed into the main body 116a, however, these features of the fiber grippers 116j could be separately formed and later connected to the top clamp block 116. In the example shown, the stand-off members 116n extend at a non-orthogonal, oblique angle a1 to a bottom surface 116p of the top clamp block main body 116a. Accordingly, the stand-off members 116n are oriented at a non-orthogonal, oblique angle to the fiber clamping surface 118a defined by the pad 118 received by the fiber grippers 116j. As most easily seen at FIG. 20, the angle a1 is between about 45 degrees and about 75 degrees, and is preferably about 66 degrees.

As most easily viewed at FIGS. 23 to 28, when the cam lever 124 is moved into the closed position, the top clamp block 116 is compressed against the bottom clamp block 108 and a closing force F is exerted onto the fiber grippers 108j, 116j such that the end members 108k, 116k are brought together, thereby compressing the pads 110, 118 onto the optical fibers 14. This closing force F is generally orthogonal to the fiber clamping surfaces 110a, 118a. As the stand-off members 108n, 116n are deflectable, the closing force F will cause the stand-off members 108n, 116n to deflect such that the end portions 108k, 116k and the pads 110, 118 are displaced not only towards the surfaces 108p, 116p of the bottom and top clamp blocks 108, 116 in a direction P towards the rear edges 110c of the pads 110 and away from the ferrules 12a. This motion generates a tensile force onto the optical fibers 14 which allows the fibers 14 to be cleaved with the cleaving tool with more consistent results. The process of placing the optical fibers under tension and then cleaving them can be characterized as including supporting the ends of optical connectors with a fiber gripping tool, placing the optical fibers extending from the optical connectors between a pair of fiber grippers, generating a closing force to cause the pair of fiber grippers to clamp the optical fiber and to pull the optical fibers in a direction away from the ferrules of the optical connectors, and cleaving the optical fiber with a cleaving tool proximate the optical connector.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the disclosure.

What is claimed is:

1. A fiber gripping tool comprising:
a) a first gripper having a first clamping surface extending between a front edge and a rear edge; and
b) a second gripper having a second clamping surface extending between a front edge and a rear edge, the second clamping surface facing the first clamping surface;
c) wherein when the first and second gripper are subjected to a closing force, the closing force causes the first and second clamping surfaces to be:
i. compressed against each other to grip an optical fiber; and
ii. displaced in a fiber pulling direction towards the rear edges of the first and second clamping surfaces.

2. The fiber gripping tool of claim 1, wherein the first clamping surface is defined by a first pad attached to the first gripper and wherein the second clamping surface is defined by a second pad attached to the second gripper.

3. The fiber gripping tool of claim 2 or any other preceding claim, wherein the first pad is received into a first recess of the first gripper and the second pad is received into a second recess of the second gripper.

4. The fiber gripping tool of claim 2 or 3 or any other preceding claim, wherein the first and second pads are formed from a polymeric material.

5. The fiber gripping tool of claim 1 or any other preceding claim, wherein the first and second grippers include a plurality of first and second grippers.

6. The fiber gripping tool of claim 5 or any other preceding claim, wherein the first and second grippers include twelve first grippers and twelve second grippers.

7. The fiber gripping tool of claim 1 or any other preceding claim, wherein the first and second grippers are respectively attached to a first block and a second block movable relative to the first block.

8. The fiber gripping tool of claim 7 or any other preceding claim, wherein the first and second grippers are respectively integrally formed with the first and second blocks.

9. The fiber gripping tool of claim 7 or any other preceding claim, wherein the first gripper includes a first flexible stand-off member and the second gripper includes a second flexible stand-off member, wherein the closing force causes the first and second flexible stand-off members to deflect such that the first and second clamping surfaces are displaced towards their rear edges.

10. The fiber gripping tool of claim 9 or any other preceding claim, wherein the first flexible stand-off member includes a pair of flexible stand-off members and the second flexible stand-off member includes a pair of flexible stand-off members.

11. The fiber gripping tool of claim 9 or 10 or any other preceding claim, wherein the first and second stand-off members are oriented at an oblique angle with respect to the first and second clamping surfaces.

12. The fiber gripping tool of claim 1 or any other preceding claim, further comprising a cleave guide for guiding a cleaving tool.

13. The fiber gripping tool of claim 12 or any other preceding claim, wherein the cleave guide is at least one of a vertical wall and a horizontal wall.

14. A fiber gripping tool comprising:
a) a first gripper defining a first end portion and a first stand-off member extending at an oblique angle from the first end portion, the first end portion defining a first clamping surface;
b) a second gripper defining a second end portion and a second stand-off member extending at an oblique angle from the second end portion, the second end portion defining a second clamping surface;
c) wherein when the first and second gripper are subjected to a closing force, the closing force causes:
i. the first and second clamping surfaces to be compressed against each other to grip an optical fiber; and
ii. the first and second stand-off members to deflect, thereby displacing the first and second clamping surfaces in a first direction parallel to the first and second clamping surfaces.

15. The fiber gripping tool of claim 14 or any other preceding claim, wherein the first clamping surface is defined by a first pad attached to the first gripper and wherein the second clamping surface is defined by a second pad attached to the second gripper.

16. The fiber gripping tool of claim 15 or any other preceding claim, wherein the first pad is received into a first recess of the first gripper and the second pad is received into a second recess of the second gripper.

17. The fiber gripping tool of claim 15 or 16 or any other preceding claim, wherein the first and second pads are formed from a polymeric material.

18. The fiber gripping tool of claim 14 or any other preceding claim, wherein the first and second grippers include a plurality of first and second grippers.

19. The fiber gripping tool of claim 18 or any other preceding claim, wherein the first and second grippers include twelve first grippers and twelve second grippers.

20. The fiber gripping tool of claim 14 or any other preceding claim, wherein the first and second grippers are respectively attached to a first block and a second block movable relative to the first block.

21. The fiber gripping tool of claim 20 or any other preceding claim wherein the first and second grippers are respectively integrally formed with the first and second blocks.

22. A method for gripping and cleaving an optical fiber extending from an optical connector, the method comprising:
a) supporting an end of the optical connector with a fiber gripping tool;
b) placing the optical fiber extending from the optical connector between a pair of fiber grippers;
c) generating a closing force to cause the pair of fiber grippers to clamp the optical fiber and to pull the optical fiber in a direction away from the optical connector; and
d) cleaving the optical fiber with a cleaving tool proximate the optical connector.

23. The method of claim 22 or any other preceding claim, wherein the step of generating a closing force includes operating a lever of the fiber gripping tool into a clamped position.

24. The method of claim 22 or any other preceding claim, wherein the closing force causes the fiber grippers to simultaneously clamp and pull the optical fiber.

25. The method of claim 22 or any other preceding claim, wherein the closing force causes flexible stand-off members of the fiber grippers to deflect.

26. The method of claim 22 or any other preceding claim, wherein the supporting, placing, and generating a closing force steps include supporting a plurality of optical connectors, placing a plurality of optical fibers between one or more pairs of fiber grippers, and generating a closing force on the plurality of optical fibers to cause the one or more pairs of fiber grippers to clamp each of the plurality of optical fibers and to pull each of the plurality of optical fibers in a direction away from the optical connectors.
